(19) United States
(12) Patent Application Publication
(10) Pub. No.: US 2017/0241902 A1
(43) Pub. Date: Aug. 24, 2017

(54) METHOD FOR CORRECTING AN INFRARED ABSORPTION SPECTRUM

(71) Applicants: INSTITUT NATIONAL DE LA SANTE ET DE LA RECHERCHE MEDICALE (INSERM), Paris (FR); UNIVERSITÉ DE BORDEAUX, Bordeaux (FR)

(72) Inventors: Cyril PETIBOIS, Pessac (FR); Adrien TRAVO, Talence Cedex (FR); Vladimir BOBROFF, Talence (FR)

(21) Appl. No.: 15/503,418

(22) PCT Filed: Aug. 7, 2015
(86) PCT No.: PCT/EP15/68315

§ 371 Date: Feb. 13, 2017

(30) Foreign Application Priority Data
Aug. 20, 2014 (EP) 14306300.6

(51) Int. Cl. G01N 21/27; G01N 21/35; G01J 3/42; G01J 3/02

(52) U.S. Cl. CPC G01N 21/274; G01J 3/0297; G01N 21/35; G01J 3/42; G01N 2201/127; G01J 2003/283

(57) ABSTRACT

A method for correcting an infrared absorption spectrum comprises the steps of:—providing a measured infrared absorption spectrum from a sample,—determining a baseline correction curve by using at least one spectral interval in which an absorption quantity is expected to be null for at least two wavelength quantities,—subtracting the baseline correction curve from the measured infrared absorption spectrum, to obtain a first corrected absorption spectrum,—extracting at least one absorption band whose position is out of the fingerprint region,—comparing each extracted absorption band with the expected absorption band,—correcting the baseline correction curve in accordance with the results of the comparing step, to obtain a corrected baseline correction curve, and—subtracting the corrected baseline correction curve from the measured infrared absorption spectrum, to obtain a second corrected absorption spectrum.

### TECHNICAL FIELD OF THE INVENTION

The present invention concerns a method for correcting an infrared absorption spectrum. The present invention also concerns the associated spectrometers and computer program products.

### BACKGROUND OF THE INVENTION

Biological samples are biological tissues comprising diverse cell populations and compounds. Each cell population exhibits specific metabolic and biochemical characteristics which are organized and/or distributed in three dimensions. Each compound influences the overall behavior of the analyzed tissues. Therefore, it is desirable to study the evolution of these compounds and the different cell populations of a biological sample in three dimensions.

To follow the evolution of tissue compounds, histopathology techniques are known. Histopathology refers to the microscopic examination of tissues in order to study the manifestations of disease. Specifically, in clinical medicine, histopathology refers to the examination of a biopsy or surgical specimen by a pathologist, after the specimen has been processed and histological sections have been placed onto glass slides. In contrast, cytopathology examines free cells or tissue fragments.

Immunohistochemistry and immunofluorescence are two widely used histopathology techniques.

Immunohistochemistry or IHC refers to the process of detecting labels—mostly antigens—in cells or interstitial chemicals of a tissue section by exploiting the principle of antibodies binding specifically to antigens in biological tissues. The procedure was conceptualized and first implemented by Dr. Albert Coons in 1941. Visualizing an antibody-antigen interaction can be accomplished in a number of ways. In the most common instance, an antibody is conjugated to an enzyme, such as peroxidase, that can catalyze a colour-producing reaction.

Alternatively, the antibody can also be tagged to a fluorophore, such as fluorescein or rhodamine. Such technique is called immunofluorescence or IF. This technique is thus a widely used example of immunostaining and a specific example of immunohistochemistry that makes use of fluorophores to visualize the location of the antibodies. Immunofluorescence can be used on tissue sections, cultured cell lines, or individual cells, and may be used to analyze the distribution of proteins, glycans, and small biological and non-biological molecules. Immunofluoresence can be used in combination with other, non-antibody methods of fluorescent staining, for example, use of DAPI to label DNA. Several microscope designs can be used for analysis of immunofluorescence samples; the simplest is the epifluorescence microscope, and the confocal microscope is also widely used. Various super-resolution microscope designs that are capable of much higher resolution can also be used.

However, immunohistochemistry and immunofluorescence are histopathology imaging techniques which do not provide access to the spatially ordered chemical and cell compounds within the analyzed tissue. Moreover, these techniques do not enable to provide a quantitative measurement of sample contents. These techniques are also limited in the number of analyzed compounds on a single sample due to the poor compatibility between labels.

Such quantitative and more global measurement of sample contents can notably be provided by spectroscopic techniques. By definition, spectroscopy is the study of the interaction between matter and radiated energy over a broad wavelength region. Thus, multiple experimental techniques are spectroscopic techniques. Infrared spectroscopy, Raman spectroscopy, mass-spectrometry, X-ray fluorescence are examples of spectroscopic techniques providing quantitative measurement of sample contents.

Recent initiatives have demonstrated that three-dimensional infrared imaging can be reconstructed by stacking two-dimensional images of tissue sections. An example of such technique is notably described in the article from B. R. Wood et al., whose title is “A three-dimensional multivariate image processing technique for the analysis of FTIR spectroscopic images of multiple tissue sections” and published in the review BMC Med Imaging 6 (12), 1 (2006).

It has also been proposed to co-add several view angles from the same sample volume for a tomographic reconstruction. This approach is notably developed in the article from M. C. Martin et al., whose title is “3D spectral imaging with synchrotron Fourier transform infrared spectro-microtomography” and published in the review Nat Methods 10 (9), 861 (2013).

The use of synchrotron radiation has been considered as a valuable alternative to the Globar sources for obtaining high signal/noise values, which limited the quantitative artifacts in three-dimensional reconstruction. Such idea is notably developed in the article from C. Petibois et al., whose title is “A bright future for synchrotron imaging” and published in the review Nat Photonics 3 (4), 179 (2009). This idea can also be found in the article from F. Jamme et al., whose title is “Synchroton infrared confocal microscope: Application to infrared 3D spectral imaging” and published in the review J Phys: Conf Series 425 (142002), 1 (2012).

However, the use of such techniques implies the use of radiation sources with relatively high power. Synchrotrons for X-ray fluorescence or ion sources for mass-spectrometry are examples of such radiation sources. The use of such power sources limits the development of the spectroscopic techniques in clinics. Notably, the synchrotron facility is not easily accessible which prevents considering using a technique implying a synchrotron radiation source. It must be also mentioned that such infrared source is not considered as stable enough to allow long-lasting spectral data acquisitions, which thus limits the capacity to analyze large tissue samples at high spectral and pixel resolutions.

Moreover, the detectors used in clinics are usually of small dimensions, thus restricting the applicability of imaging methods to small sample areas or volumes.

Additionally, such techniques remain poorly serviceable for end users who are not specialists of their utilization, i.e. for clinicians and biologists.

In addition, none of the above-mentioned techniques enable to achieve three-dimensional sample imaging at a large scale, that is, for instance, a volume of 1 cm³ for a biopsy of surgical exeresis.

Methods for correcting transmission spectrum are also known from the document U.S. 2012/287418, the article whose title is “Investigation of Selected Baseline Removal Techniques as Candidates for Automated Implementation” by Georg SCHULZE et al., the article whose title is “A New Baseline Correction Algorithm Using Objective Criteria” by Juwhan LIU et J. L. KOENIG and the article whose title is “Automatic baseline correction of infrared spectra” by T. LAN et al.

### SUMMARY OF THE INVENTION

There is therefore a need for a method for correcting an infrared absorption spectrum that alleviates at least partly the above-mentioned defects.

To this end, it is proposed a method for correcting an infrared absorption spectrum, a spectrum being the evolution of a absorption quantity with regards to a wavelength quantity in a predefined range of wavelength quantity, the absorption quantity being a quantity representative of the absorption and the wavelength quantity being a quantity representative of the wavelength, the method for correcting an infrared absorption spectrum at least comprising the steps of:
providing a measured infrared absorption spectrum from a sample,
determining a first baseline correction curve by using at least one spectral interval in which absorption quantity is expected to be null for at least two wavelength quantities,
subtracting the first baseline correction curve from the measured infrared absorption spectrum, to obtain a first corrected absorption spectrum,
from the first corrected absorption spectrum, extracting at least one absorption band whose position is located out of the fingerprint region, an absorption band being a mathematical profile associated to at least one covalent bond of chemical species present in the sample, the mathematical profile being characterized by mathematical parameters, one parameters of the mathematical parameters being the position, the position being the wavelength quantity of the absolute maximum of absorption quantity of the considered absorption band,
comparing each extracted absorption band with the expected absorption band,
correcting the first baseline correction curve in accordance with the results of the comparing step, to obtain a corrected baseline correction curve, and
subtracting the corrected baseline correction curve from the measured infrared absorption spectrum, to obtain a second corrected absorption spectrum.

According to further aspects, which are advantageous but not compulsory, the method for correcting an infrared absorption spectrum might incorporate one or several of the following features, taken in any admissible combination:
the correcting step further comprises at least the steps of calculating a residual spectrum by subtracting each extracted absorption band from the first corrected absorption spectrum, and refining the first baseline correction curve by using the residual spectrum as a supplementary calculation material to obtain a corrected baseline correction curve.
at the determining step, the first baseline correction curve is an interpolation curve chosen in a group consisting of polynomial function, preferably a polynomial of an order inferior or equal to 4, spline function, preferably based on polynomial functions of an order inferior or equal to 4, and a linear combination of polynomial functions and/or spine functions.
the distribution profile is chosen among a Gaussian profile, a Lorentzian profile and a Voigt profile, the Voigt profile being characterized by a Gaussian proportion and a Lorentzian proportion.
one parameter of the mathematical parameters is the width of the absorption band.
one parameter of the mathematical parameters is the full width at half maximum of the absorption band.
the extracting step comprises the steps of searching the absorption band(s) in the first corrected absorption spectrum, to obtain found absorption band(s), and deducing values to mathematical parameters of each found absorption band, to obtain deduced parameters.
the extracting step further comprises defining each absorption band by using the deduced parameters of the absorption band and a distribution profile.
the refining step comprises for each extracted absorption band determining the algebraic sign of the residual spectrum at the position of the considered absorption band and/or at the extremities of the width of the considered absorption band, and/or analyzing the symmetry of the residual spectrum with relation to the position of each considered absorption band.
at the extracting step, all the absorption bands whose position is located out of the fingerprint region are extracted.

It is also proposed a spectrometer comprising a radiation source, optics to transport the radiation emitted by the radiation source towards the sample, a sample holder, a detector and a calculator adapted to carry out a method as described here above.

It also concerns a computer program product comprising a computer readable medium, having thereon a computer program comprising program instructions, the computer program being loadable into a data-processing unit and adapted to cause execution of a method as described here above.

### BRIEF DESCRIPTION OF THE DRAWINGS

The invention will be better understood on the basis of the following description, which is given in correspondence with the annexed figures and as an illustrative example, without restricting the object of the invention. In the annexed figures:

FIG. 1 is a schematic representation of a system and a computer program product, whose interaction enables to carry out a method for correcting an infrared absorption spectrum,

FIG. 2 is a flowchart of an example of carrying out of the method for correcting an infrared absorption spectrum,

FIGS. 3 to 7 are graphs illustrating an absorbance spectrum, that is the evolution of the absorbance with the wavenumber, and

FIG. 8 is a schematic representation of a spectrometer.

### DETAILED DESCRIPTION OF SOME EMBODIMENTS

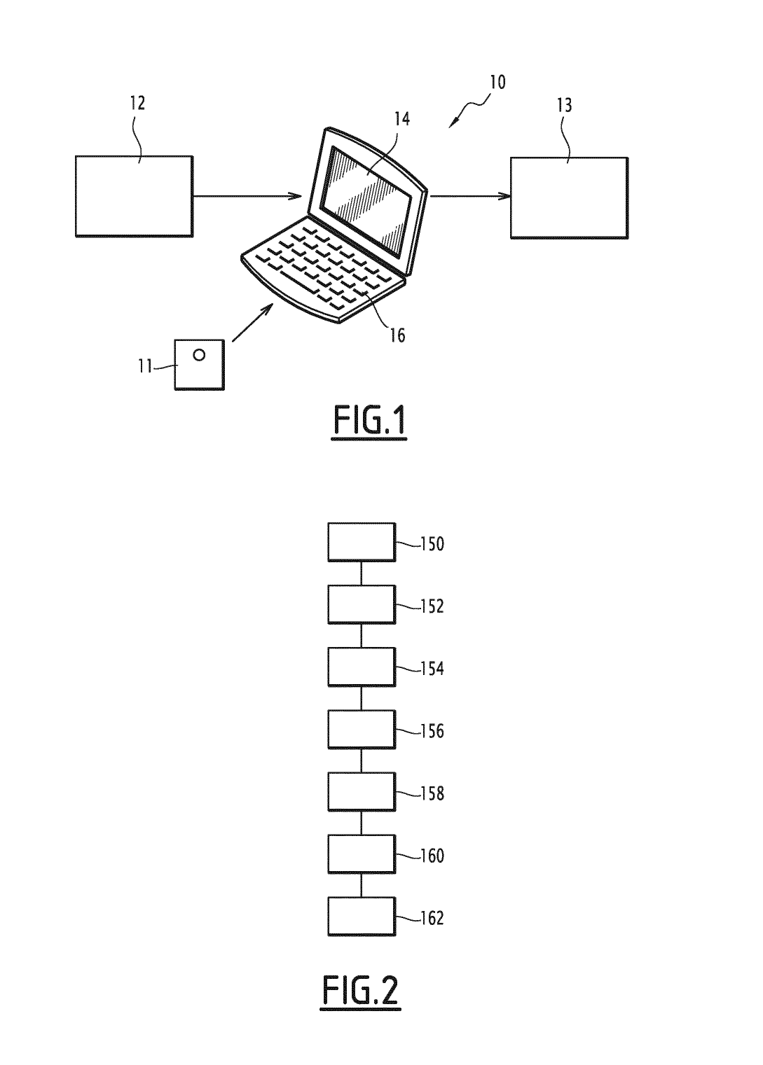

A system 10 and a computer program product 11 are represented in FIG. 1. The interaction between the computer program product 11 and the system 10 enables to carry out a method for determining at least one absorption band associated to a covalent bonds of chemical species present in a sample. This is symbolized in FIG. 1 by the two boxes 12 and 13. The first box corresponds to the input, which is, in this context, a spectrum. The second box corresponds to the output, which is, in this context, a corrected absorption spectrum.

System 10 is a computer. In the present case, system 10 is a laptop.

More generally, system 10 is a computer or computing system, or similar electronic computing device adapted to manipulate and/or transform data represented as physical, such as electronic, quantities within the computing system's registers and/or memories into other data similarly represented as physical quantities within the computing system's memories, registers or other such information storage, transmission or display devices.

System 10 comprises a processor, a keyboard 14 and a display unit 16.

The processor comprises a data-processing unit, memories and a reader adapted to read a computer readable medium.

The computer program product 11 comprises a computer readable medium.

The computer readable medium is a medium that can be read by the reader of the processor. The computer readable medium is a medium suitable for storing electronic instructions, and capable of being coupled to a computer system bus.

Such computer readable storage medium is, for instance, a disk, a floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

A computer program is stored in the computer readable storage medium. The computer program comprises one or more stored sequence of program instructions.

The computer program is loadable into the data-processing unit and adapted to cause execution of the method for determining absorption bands when the computer program is run by the data-processing unit.

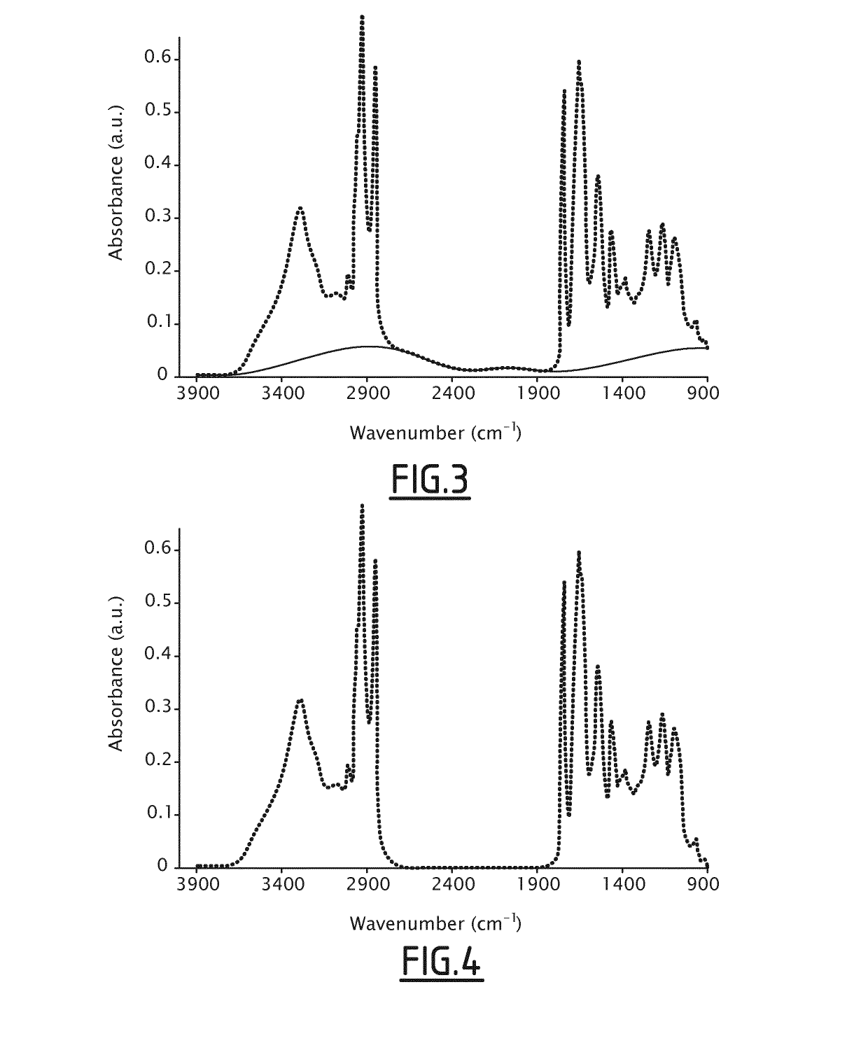

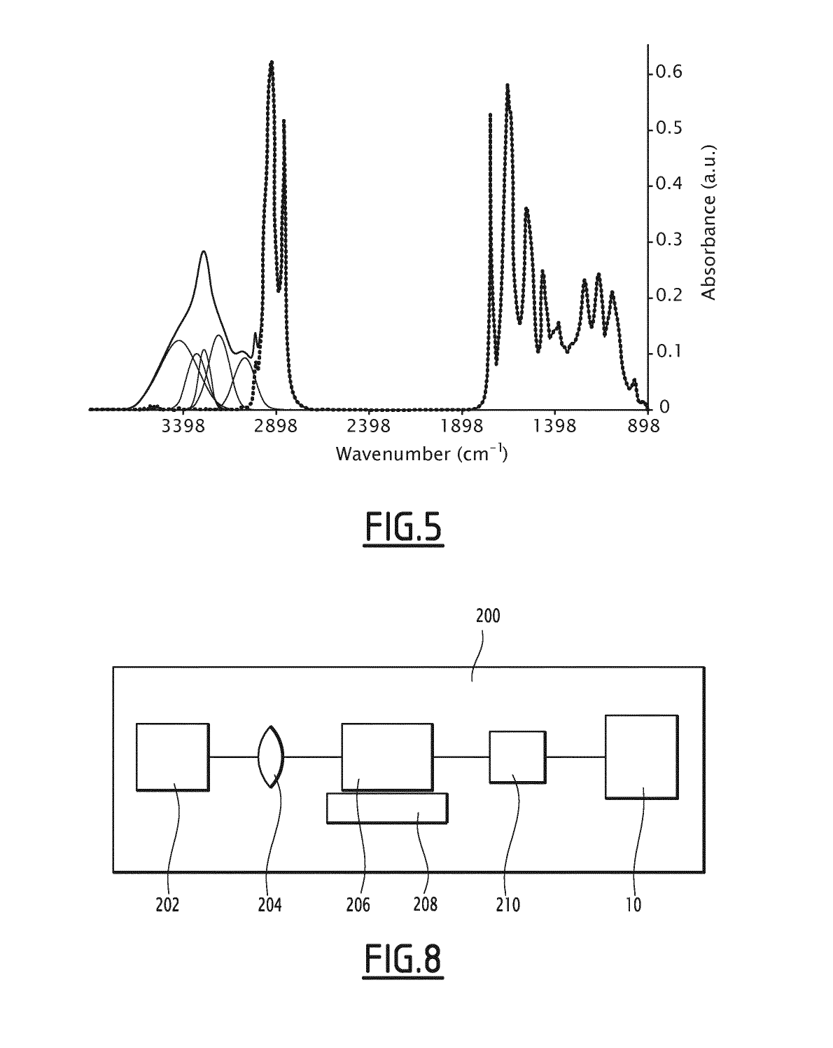

Operation of the system 10 is now described in reference to the flowchart of FIG. 2, which illustrates an example of carrying out the method for correcting an infrared absorption spectrum. Such method for correction is detailed below in reference to FIGS. 3 to 7 showing the obtained spectra and the baseline correction curve.

The method for correcting comprises a step 150 of providing a measured infrared absorption spectrum from a sample.

The measured absorption spectrum is labeled S_{MEASURED} in the remainder of the specification.

By definition, a spectrum is a set of spectroscopic data representing the evolution of an absorption quantity with regards to a wavelength quantity in a predefined range of wavelength quantity.

The absorption quantity is a quantity representative of the absorption. For instance, the intensity of the absorption or the absorbance are absorption quantities.

The wavelength quantity is a quantity representative of the wavelength. For instance, the frequency, the wavenumber or the wavelength are quantities representative of the wavelength.

The predefined range of wavelength quantity represents the wavelength domains for which data are available.

In the remainder of the description, as an example, it will be considered that the absorption quantity is absorbance and the wavelength quantity is the wavenumber. However, each feature related to absorbance can be applied to another absorption quantity. Similarly, each feature related to wavelength quantity can be applied to another wavelength quantity. Thus, in the remainder of the description, it is considered that an absorption spectrum is a set of spectroscopic data representing the evolution of absorbance with regards to wavenumber in a predefined range of wavenumber.

Absorption spectroscopy refers to spectroscopic techniques that measure the absorption of radiation, as a function of frequency or wavelength, due to its interaction with a sample. The sample absorbs energy, i.e., photons, from the radiating field. The absorption quantity varies as a function of wavelength quantity, and this variation is the absorption spectrum. Absorption spectroscopy is thus performed across the electromagnetic spectrum.

This means that the predefined range of wavenumber may, generally, be any portion of the electromagnetic spectrum, such as visible, ultraviolet or infrared.

Preferably, the predefined range of wavenumber is such that the absorption spectroscopy is an infrared spectroscopy.

More preferably, the predefined range of wavenumber extends between 7000 cm⁻¹ and 10 cm⁻¹ (this corresponds to a range of wavelength comprised between 1.5 microns and 1000 microns).

There are a wide range of experimental approaches to measuring absorption spectrum. The most common arrangement is to direct a generated beam of radiation at a sample and detect the intensity of the radiation that passes through it. The transmitted energy can be used to calculate the absorption. The source, sample arrangement and detection technique vary significantly depending on the frequency range and the purpose of the experiment.

Therefore, the step 150 of providing a measured absorption spectrum from the sample is achieved by providing any spectrum from which the absorption spectrum can be obtained.

Notably, the absorption spectrum can be derived from a transmission spectrum. Indeed, absorption and transmission spectra represent equivalent information and one can be calculated from the other through a mathematical transformation. A transmission spectrum will have its maximum intensities at wavelengths where the absorption is weakest because more light is transmitted through the sample. An absorption spectrum will have its maximum intensities at wavelengths where the absorption is strongest.

Alternatively, the absorption spectrum results from an emission spectrum. Emission is a process by which a substance releases energy in the form of electromagnetic radiation. Emission can occur at any frequency at which absorption can occur, and this allows the absorption lines to be determined from an emission spectrum. The emission spectrum will typically have a quite different intensity pattern from the absorption spectrum, though, so the two are not equivalent. The absorption spectrum can be calculated from the emission spectrum using appropriate theoretical models and additional information about the quantum mechanical states of the substance.

According to another embodiment, the absorption spectrum can be derived from a scattering or reflection spectrum. The scattering and reflection spectra of a material are influenced by both its index of refraction and its absorption spectrum. In an optical context, the absorption spectrum is typically quantified by the extinction coefficient, and the extinction and index coefficients are quantitatively related through the Kramers-Kronig relation. Therefore, the absorption spectrum can be derived from a scattering or reflection spectrum. This typically requires simplifying assumptions or models, and so the derived absorption spectrum is an approximation.

In a preferred embodiment, the step 150 of providing a measured absorption spectrum from the sample is achieved by carrying out an absorption experiment on the sample.

The most straightforward approach to carry out such an absorption spectroscopy experiment is to generate radiation with a source, measure a reference spectrum of that radiation with a detector and then re-measure the sample spectrum after placing the material of interest in between the source and detector. The two measured spectra can then be combined to determine the material's absorption spectrum. The sample spectrum alone is not sufficient to determine the absorption spectrum because it will be affected by the experimental conditions—the spectrum of the source, the absorption spectra of other materials in between the source and detector and the wavelength dependent characteristics of the detector. The reference spectrum will be affected in the same way, though, by these experimental conditions and therefore the combination yields the absorption spectrum of the material alone.

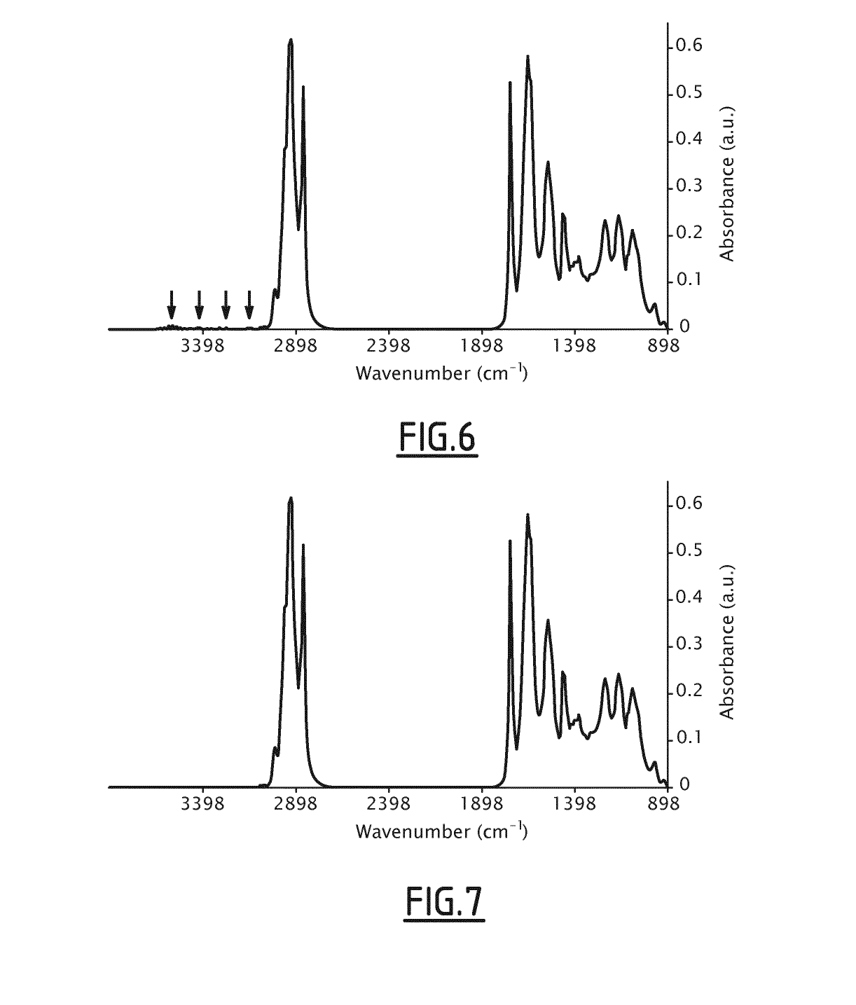

The method for correcting an infrared absorption spectrum also comprises a step 152 of determining a baseline correction curve by using at least one spectral interval in which absorption quantity is expected to be null for at least two wavelength quantities. Such step 152 of determining is notably illustrated by FIG. 8.

The presence of absorption in such spectral interval is a manifestation of the presence of the environment. Such presence perturbs the absorption measurement and should be corrected.

The baseline correction curve is determined by an interpolation taking into account the spectral intervals devoid of absorption in the infrared spectrum.

Preferably, the interpolation sets that the absorbance linked to the spectral intervals comprised between 4000 cm⁻¹ and 3700 cm⁻¹ and between 2700 cm⁻¹ and 1850 cm⁻¹ should be zero. By definition, a value is comprised between A and B if the value is superior or equal to A and if the value is inferior or equal to B.

According to a preferred embodiment, the interpolation also sets that the baseline correction curve is polynomial.

Preferably, the baseline correction curve is a polynomial of an order inferior to 4.

Alternately, the interpolation sets that the baseline correction curve is a spline function.

Preferably, the spline function is based on polynomial functions of an order inferior or equal to 4.

In another embodiment, the baseline correction curve is a linear combination of polynomial functions.

In another embodiment, the baseline correction curve is a linear combination of spline functions.

In another embodiment, the baseline correction curve is a linear combination of polynomial functions and spline functions.

The method for correcting an infrared absorption spectrum also comprises a step 154 of subtracting the baseline correction curve from the measured infrared absorption spectrum, to obtain a first corrected absorption spectrum. Such step 154 of subtracting is notably illustrated by FIG. 4.

The method for correcting an infrared absorption spectrum also comprises a step 156 of extracting at least one absorption band whose position is out of the fingerprint region. Each absorption band is a distribution profile associated to a covalent band of chemical species present in a sample.

By the term “extracting” in this context, it should be understood that each extracted absorption band is a modeled absorption band.

By definition a covalent bond is a chemical bond that involves the sharing of electron pairs between atoms. The stable balance of attractive and repulsive forces between atoms when the atoms share electrons is known as covalent bonding. For many molecules, the sharing of electrons allows each atom to attain the equivalent of a full outer shell, corresponding to a stable electronic configuration.

Covalent bonding includes many kinds of interactions, including σ-bonding, π-bonding, metal-to-metal bonding, agostic interactions, and three-center two-electron bonds.

Covalent bonding applies to two or more identical atoms, two different atoms or any other combination of different kinds of atoms. Covalent bonding that entails sharing of electrons over more than two atoms is said to be delocalized.

The frequencies where absorption occurs, as well as their relative intensities, primarily depend on the electronic and molecular structure of the sample. The frequencies will also depend on the interactions between compounds in the sample, the crystal structure in solids, supramolecular organization (polymers, inter-molecular bonds . . . ), and on several environmental factors (for instance, temperature, pressure, electromagnetic field). The absorption bands will also have a width and shape that are primarily determined by the spectral density or the density of states of the system.

Absorption bands are typically classified by the nature of the quantum mechanical change induced in the molecule or atom. Rotational bands, for instance, occur when the rotational state of a molecule is changed. Rotational bands are typically found in the microwave spectral region. Vibrational bands correspond to changes in the vibrational state of the molecule and are typically found in the infrared region. Electronic bands correspond to a change in the electronic state of an atom or molecule and are typically found in the visible and ultraviolet region. X-ray absorptions are associated with the excitation of inner shell electrons in atoms. These changes can also be combined (e.g. rotation-vibration transitions), leading to new absorption bands at the combined energy of the two changes.

The energy associated with the quantum mechanical change primarily determines the frequency of the absorption line but the frequency can be shifted by several types of interactions. Electric and magnetic fields can cause a shift. Interactions with neighboring molecules can cause shifts. For instance, absorption bands of the gas phase molecule can shift significantly when that molecule is in a liquid or solid phase and interacting more strongly with neighboring molecules.

Observed absorption bands always have a width and shape that is determined by the instrument used for the observation, the material absorbing the radiation and the physical environment of that material. Thus, the mathematical distribution of an absorption band is a distribution profile which is characterized by mathematical parameters. A Gaussian or a Lorentzian distribution are examples of distribution. Intensity, width and position are examples of mathematical parameters.

By definition, the position is the wavelength quantity of the absolute maximum of absorption quantity of the considered absorption band.

In the current case, each absorption band has a width extending between two extremities. The width is defined as the full width at half maximum (also labeled FHWM). Such width corresponds to the extent of a function, given by the difference between the two extreme values of the independent variable at which the dependent variable is equal to half of its maximum value. In other words, the width is defined by the two specific wavelength quantities associated to its extremities.

A sample is preferably a biological sample or any other organic matter-containing sample. These include notably the biological tissues and cells, synthetic biomaterials, vegetal species, kerogens-containing samples (bituminous sands, fossils, asphalts . . . ), and industrial materials (gums, polymers, plastics, rubbers, paints, glues . . . ).

The fingerprint region is a spectral region which wavenumber limits are set by absorption bands assignable to covalent bonds of chemical species in the sample.

In other words, the fingerprint region contains the specific absorption line of a sample.

Generally, the fingerprint region is a spectral region which extends between 1700 cm⁻¹ and 500 cm⁻¹.

The O—H covalent bond, the H—H covalent bond or the N—H absorption band are examples of covalent bond whose absorption band has a position outside of the fingerprint region.

The extracting step 156 may comprise the steps of searching the absorption band(s) in the first corrected absorption spectrum, to obtain found absorption band(s), and deducing values to mathematical parameters of each found absorption band, to obtain deduced parameters.

Optionally, the extracting step 156 may also comprise a step of defining each absorption band by using the deduced parameters of the absorption band and a distribution profile.

Preferably, the distribution profile is chosen among a Gaussian profile, a Lorentzian profile and a Voigt profile, the Voigt profile being characterized by a Gaussian proportion and a Lorentzian proportion.

Optionally, the extracting step 156 may comprise carrying out a step chosen in the group consisting of obtaining the maxima of the first corrected absorption spectrum, calculating the first derivative of the absorption quantity with relation to the wavelength quantity, to obtain a first derivative of the first corrected absorption spectrum, calculating the second derivative of the absorption quantity with relation to the wavelength quantity, to obtain a second derivative of the first corrected absorption spectrum, and obtaining the minima of the second derivative of the first corrected absorption, the second derivative being the second derivative of the absorption quantity with relation to the wavelength quantity.

The method for correcting an infrared absorption spectrum also comprises a step 158 of comparing each extracted absorption band with the expected absorption band.

The expected absorption band is the theoretical absorption band which can be obtained from the knowledge of the covalent band of chemical species present in the sample which have been considered to obtain the extracted absorption band.

For instance, if the covalent bond is O-H, the expected absorption band is the theoretical absorption band of such covalent bond.

The comparison notably comprises comparing the shapes of the expected absorption band and of the extracted absorption band.

The method for correcting an infrared absorption spectrum also comprises a step 160 of correcting the baseline correction curve in accordance with the results of the step 158 of comparing, to obtain a corrected baseline correction curve. Such step 160 of correcting is notably illustrated by FIG. 6.

According to a preferred embodiment, the correcting step 160 comprises a step of calculating a residual spectrum by subtracting each extracted absorption band from the first corrected absorption spectrum, and a step of refining the first baseline curve by using the residual spectrum as a supplementary calculation material to obtain a corrected baseline correction curve.

Indeed, such way of carrying out the correcting step 160 is easy to implement.

In a specific embodiment, the step of refining comprises, for each extracted absorption band, determining the algebraic sign of the residual spectrum at the position of the considered absorption band.

According to an embodiment, the step of refining comprises for each extracted absorption band, determining the algebraic sign of the residual spectrum at the extremities of the width of the considered absorption band.

Alternatively, the value of the residual spectrum considered is taken at any position which is far from the extremities of the width of the absorption band. For instance, a position which is situated at half the distance between the central position and the nearest extremity to the central position is considered as far from the extremities of the width of the absorption band.

According to an embodiment, the step of refining comprises, for each extracted absorption band, analyzing the symmetry of the residual spectrum with relation to the position of the considered absorption band.

In a preferred embodiment, in case at the step 158 of comparing, the symmetry of the considered absorption band is analyzed, at the step 160 of comparing, the baseline correction curve is corrected to ensure symmetry of the considered absorption band.

The symmetry is an efficient parameter for the comparing step since any dissymmetry corresponds to an artifact.

This enables to obtain a better corrected based curve.

The method for correcting an infrared absorption spectrum also comprises a step 162 of subtracting the corrected baseline correction curve from the measured infrared absorption spectrum, to obtain a second corrected absorption spectrum. Such step 162 of subtracting is notably illustrated by FIG. 7.

Consequently, the method for correcting an infrared absorption spectrum enables to obtain a corrected infrared absorption spectrum in which the spectral contribution of the environment has been removed with more accuracy than the method of the state of the art.

Preferably, the baseline correction curve is polynomial. Indeed, polynomials are convenient function to achieve an interpolation.

More preferably, the baseline correction curve is a polynomial of an order inferior to 4. This enables to quicken an interpolation.

According to a specific embodiment, at the determining step, the baseline correction curve is determined by an interpolation taking into account the spectral intervals devoid of absorption in the infrared spectrum.

Preferably, the interpolation sets that the value of the absorption quantities of the measured infrared absorption spectrum in the spectral intervals comprised between 4000 cm⁻¹ and 3700 cm⁻¹ and between 2700 cm⁻¹ and 1850 cm⁻¹ should be zero.

The methods and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

For instance, a spectrometer 200 including the system 10, as illustrated on FIG. 8, is proposed.

Such spectrometer 200 includes a radiation source 202, optics 204 to transport the radiation emitted by the radiation source 202 towards the sample 206, a sample holder 208, a detector 210.

A wide variety of radiation sources are employed in order to cover the electromagnetic spectrum. For spectroscopy, it is generally desirable for a source to cover a broad swath of wavelengths in order to measure a broad region of the absorption spectrum. Some sources inherently emit a broad spectrum. Examples of these include globars or other black body sources in the infrared, mercury lamps in the visible, ultraviolet and x-ray tubes, and various laser technologies emitting in the infrared range. One recently developed, novel source of broad spectrum radiation is synchrotron radiation which covers all of these spectral regions. Other radiation sources generate a narrow spectrum but the emission wavelength can be tuned to cover a spectral range. Examples of these include klystrons in the microwave region and lasers across the infrared, visible and ultraviolet region (though not all lasers have tunable wavelengths).

In the context of the present application, the radiation source 202 is preferably an infrared source adapted to emit wavelengths comprised in the predefined range of wavenumber. As explained above, this range may extend between 7000 cm⁻¹ and 10 cm⁻¹.

The materials of the optics 204 to transport the radiation emitted by the radiation source 202 towards the sample 206 are chosen in relation with the wavelength range of interest. Indeed, materials with relatively little absorption in the wavelength range of interest should be considered. For instance, the absorption should be inferior to 0.5%, preferably 0.01%. A too high absorption of other materials could interfere with or mask the absorption from the sample. For instance, in several wavelength ranges, absorption measurements of the sample 206 are made under vacuum or in a rare gas environment because gases in the atmosphere have interfering absorption features.

In the biological context, the optics is generally a microscope objective and mirrors.

A sample holder 208 also is made in a specific material, in other words, a material with relatively little absorption in the wavelength range of interest. For instance, the absorption should be inferior to 50%, preferably 0.01%.

The detector 210 employed to measure the radiation power will also depend on the wavelength range of interest. Most detectors are sensitive to a fairly broad spectral range and the sensor selected will often depend more on the sensitivity and noise requirements of a given measurement. Examples of detectors common in spectroscopy include heterodyne receivers in the microwave, bolometers in the millimeter-wave and infrared, mercury cadmium telluride and other cooled semiconductor detectors in the infrared, and photodiodes and photomultiplier tubes in the visible and ultraviolet.

Optionally, the spectrometer 200 also includes a spectrograph. The spectrograph is used to spatially separate the wavelengths of radiation so that the power at each wavelength can be measured independently. Such means of resolving the wavelength of the radiation in order to determine the spectrum is notably used in the case when both the source and the detector cover a broad spectral region. Indeed, as spectra can be reconstructed wavelength by wavelength, the spectrograph is not necessary.

The embodiments and alternative embodiments considered here above can be combined to generate further embodiments of the invention.

1. Method for correcting an infrared absorption spectrum, a spectrum being the evolution of a absorption quantity with regards to a wavelength quantity in a predefined range of wavelength quantity, the absorption quantity being a quantity representative of the absorption and the wavelength quantity being a quantity representative of the wavelength, the method for correcting an infrared absorption spectrum at least comprising the steps of
providing a measured infrared absorption spectrum from a sample,
determining a first baseline correction curve by using at least one spectral interval in which absorption quantity is expected to be null for at least two wavelength quantities,
subtracting the first baseline correction curve from the measured infrared absorption spectrum, to obtain a first corrected absorption spectrum,
from the first corrected absorption spectrum, extracting at least one absorption band whose position is located out of the fingerprint region, an absorption band being a distribution profile associated to at least one covalent bond of chemical species present in the sample, the distribution profile being characterized by mathematical parameters, one parameter of the mathematical parameters being the position, the position being the wavelength quantity of the absolute maximum of absorption quantity of the considered absorption band,
comparing each extracted absorption band with the expected absorption band,
correcting the first baseline correction curve in accordance with the results of the comparing step, to obtain a corrected baseline correction curve, and
subtracting the corrected baseline correction curve from the measured infrared absorption spectrum, to obtain a second corrected absorption spectrum.

2. Method for correcting an infrared absorption spectrum according to claim 1, wherein the correcting step further comprises at least the steps of:
calculating a residual spectrum by subtracting each extracted absorption band from the first corrected absorption spectrum, and
refining the first baseline correction curve by using the residual spectrum as a supplementary calculation material to obtain a corrected baseline correction curve.

3. Method for correcting an infrared absorption spectrum according to claim 1, wherein at the determining step, the first baseline correction curve is an interpolation curve chosen in a group consisting of:
polynomial function, preferably a polynomial of an order inferior or equal to 4.
spline function, preferably based on polynomial functions of an order inferior or equal to 4, and
a linear combination of polynomial functions and/or spine functions.

4. Method for correcting an infrared absorption spectrum according to claim 1, wherein the distribution profile is chosen among a Gaussian profile, a Lorentzian profile and a Voigt profile, the Voigt profile being characterized by a Gaussian proportion and a Lorentzian proportion.

5. Method for correcting an infrared absorption spectrum according to claim 1, wherein one parameter of the mathematical parameters is the width of the absorption band.

6. Method for correcting an infrared absorption spectrum according to claim 1, wherein the extracting step comprises the steps of:
searching the absorption band(s) in the first corrected absorption spectrum, to obtain found absorption band(s), and
deducing values to mathematical parameters of each found absorption band, to obtain deduced parameters.

7. Method for correcting an infrared absorption spectrum according to claim 6, wherein the extracting step further comprises:
defining each absorption band by using the deduced parameters of the absorption band and a distribution profile.

8. Method for correcting an infrared absorption spectrum according to claim 2, wherein the refining step comprises for each extracted absorption band:
determining the algebraic sign of the residual spectrum at the position of the considered absorption band and/or at the extremities of the width of the considered absorption band, and/or
analyzing the symmetry of the residual spectrum with relation to the position of each considered absorption band.

9. Method for correcting an infrared absorption spectrum according to claim 2, wherein at the extracting step, all the absorption bands whose position is located out of the fingerprint region are extracted.

10. Spectrometer comprising a radiation source, optics to transport the radiation emitted by the radiation source towards the sample, a sample holder, a detector and a calculator adapted to carry out a method according to claim 1.

11. Computer program product comprising a computer readable medium, having thereon a computer program comprising program instructions, the computer program being loadable into a data-processing unit and adapted to cause execution of a method according to claim 1 when the computer program is run by the data-processing unit.
